(19) United States
(12) Patent Application Publication
(10) Pub. No.: US 2009/0176197 A1
(43) Pub. Date: Jul. 9, 2009

(54) HYDROSTATIC TRAINING DEVICE

(75) Inventors: Harald Vogt, Ulm (DE); Joerg Geiger, Ulm (DE); Martin Theiss, Weissenhorn (DE)

Correspondence Address: SCULLY SCOTT MURPHY & PRESSER, PC, 400 GARDEN CITY PLAZA, SUITE 300, GARDEN CITY, NY, 11530, US

(73) Assignee: BOSCH REXROTH AG, Stuttgart (DE)

(21) Appl. No.: 12/162,677

(22) PCT Filed: Feb. 14, 2007
(86) PCT No.: PCT/EP2007/001287

§ 371 Date: Jul. 30, 2008

(30) Foreign Application Priority Data
Feb. 16, 2006 (DE) 10 2006 007 296.0
May 18, 2006 (DE) 10 2006 023 440.5

(51) Int. Cl. G09B 23/12; G09B 25/02

(52) U.S. Cl. 434/302; 434/401

(57) ABSTRACT

The invention relates to a hydrostatic training device. The hydrostatic training device (1) comprises a frame body (12) to which a hydrostatic pump (3) is fixed. Furthermore, a hydrostatic consumer (5) is connected to the hydrostatic pump (3) in a hydrostatic, closed circuit. The training device (1) furthermore comprises a control console (23) for controlling the hydraulic circuit.

From DE 43 44 609 A1, it is known to use a hydrostatic teaching or training device in order to be able to represent physical relationships within hydrostatic systems in a realistic manner. To this end, the teaching and training device comprises a pump which draws pressure medium from a tank space and supplies it to a hydraulic cylinder. By measuring volume flows and part-volume flows, it is possible to illustrate the hydraulic principles.

The known teaching and training device has the disadvantage that, although the basic principles of hydraulic systems can be illustrated, this does not allow a realistic simulation of an actual system and the representation of various operating states.

The object of the invention is to provide a hydrostatic training device which reflects the operational behaviour of actual hydrostatic drives and can also be used with clients for demonstration purposes.

The object is achieved with the hydrostatic training device according to the invention having the features of claim 1.

The hydrostatic training device according to the invention comprises a frame member on which a hydrostatic pump and a hydrostatic consumer which is connected thereto in a closed circuit are arranged. Furthermore, an operator console is provided by means of which the hydrostatic circuit is controlled. Owing to such an arrangement of a first hydrostatic pump in a closed circuit with a hydrostatic consumer, it is possible to simulate situations of a closed hydraulic circuit in a realistic manner and demonstrate reactions to user input via an operator console. To this end, in accordance with the operation of an actual operating device, for example, of a digger, an operator console is provided by means of which the hydraulic circuit or the components thereof can be controlled.

Advantageous developments of the hydrostatic training device according to the invention are set out in the subsidiary claims.

According to an advantageous configuration, the hydrostatic consumer is a hydraulic motor. Owing to the connection of a hydraulic motor of this type to a hydrostatic pump in a closed circuit, it is also possible to simulate in particular travel drives in a realistic manner using the hydrostatic training device.

In a more preferred manner, there is arranged on the training device an extension arm by means of which a load can be produced for the circuit. In order to provide a variable load for the hydraulic circuit, the inclination of the extension arm relative to the frame member can be adjusted.

To this end, the extension arm is preferably fixed to the frame member by means of a rotary bearing. This may in particular be arranged at one end of the extension arm. The axis of rotation of the rotary bearing extends in a horizontal plane, in particular perpendicularly relative to the longitudinal extent of the extension arm. In order to be able to simulate load states which change during operation, the inclination of the extension arm can preferably be adjusted by means of a hydraulic cylinder. By activating the hydraulic cylinder, one end of the extension arm is raised relative to the rotary bearing and consequently the inclination relative to the horizontal is changed.

The angular range within which the inclination of the extension arm can be adjusted is preferably at least 90° and is orientated in such a manner that the extension arm can be arranged both in the horizontal and in the vertical. Preferably, a slide is connected to the extension arm, the slide being able to be displaced in the direction of the longitudinal axis of the extension arm. It is thereby possible to simulate a linear movement by displacing the slide on the extension arm in two directions. In order to produce such a translation movement of the slide relative to the extension arm, the slide co-operates with a linear drive. The linear drive is preferably driven by the hydraulic motor by means of a ball screw drive. The ball screw drive and the hydraulic motor are arranged in particular at the side of the extension arm facing the rotary bearing. When the inclination of the extension arm is changed relative to the frame member, only a small change is consequently produced in the position of the hydraulic motor which is arranged at the end-face on the extension arm. This is significant in particular owing to the lines which connect the first hydraulic pump to the hydraulic motor.

In order to be able to simulate different acceleration and braking situations, for example, also for a journey in the plane in which the extension arm is arranged in a horizontal manner, the slide is preferably loaded with weight elements which are combined to form one weight. The number of weight elements can be changed so that variable loading can be produced without the inclination of the extension arm having to be varied.

Furthermore, it is advantageous to provide, in addition to the closed circuit, an open circuit which comprises a second hydrostatic pump. Owing to the additional provision of the open circuit, it is possible, for example, as an addition to a travel drive and independently of such a travel drive, to adjust the inclination and consequently the peripheral condition for the travel drive. To this end, the lifting cylinder which determines the inclination of the extension arm is connected to the second hydraulic pump of the open circuit.

The open circuit can preferably also be controlled by means of an operator console. In particular, it is advantageous for the open circuit and the closed circuit to be able to be operated independently of each other. It is thereby possible to first produce a specific situation by controlling the open circuit. In this situation, which defines the external conditions for the travel drive, the behaviour of the travel drive itself for various travel situations can now be simulated by the closed circuit.

A particularly suitable training device is produced if the frame member is constructed in a parallelepipedal manner. The base face of the parallelepipedal frame member is preferably extended at one side by extending a lower frame, so that an adjustment face is produced. In order to have an extended displacement path, it is also possible to dispense with the adjustment face. The frame member itself is preferably formed from profile rods which allows good accessibility to the hydraulic components. The profile rods which form the open frame member allow the hydraulic components of the open and/or the closed circuit to be arranged so as to be accessible from the outer side. Such an arrangement of the hydraulic components which is accessible from the outer side facilitates the replacement of the hydraulic components. Simple replacement is, for example, advantageous in order to be able to simulate different travel drives or other hydraulic drives after brief modification of the training device. In place of the profile rods which comprise, for example, aluminium profiles, it is also possible to use steel pipes.

Furthermore, it is preferable to arrange the hydraulic components of the closed circuit and/or the open circuit so as to be visible from the outer side. An arrangement which is visible from the outer side may also be provided if accessibility is prevented in the danger region, for example, owing to glazing of the lateral faces of the parallelepipedal frame member or a transparent covering hood. Such an arrangement can advantageously be used, for example, at exhibitions.

A preferred configuration of the invention is illustrated in the drawings and is explained in greater detail in the following description:

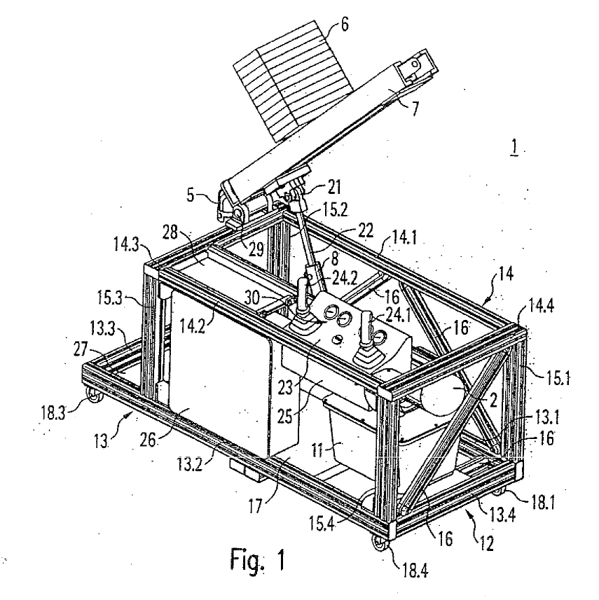

FIG. 1 is a first perspective illustration of a hydrostatic training device according to the invention;

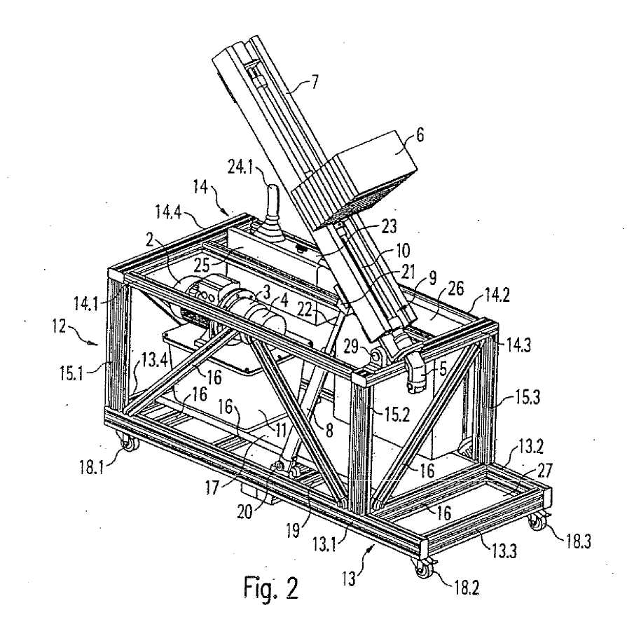

FIG. 2 is a second perspective illustration of the hydrostatic training device according to the invention;

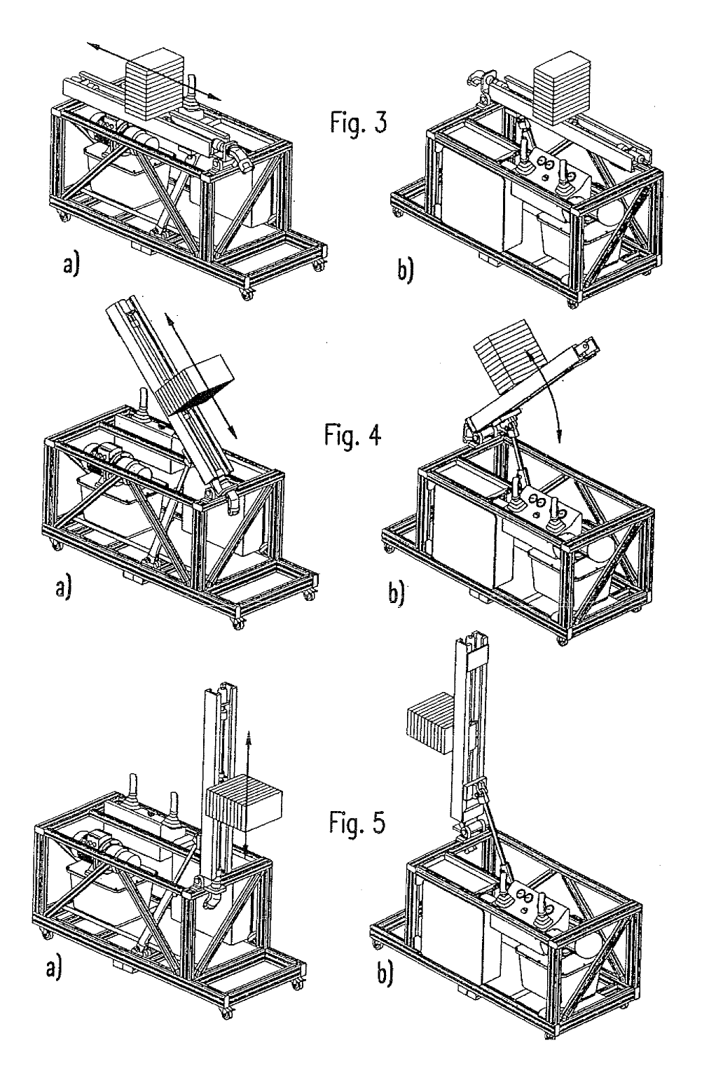

FIGS. 3a,b are schematic illustrations to simulate a first hydrostatic drive;

FIGS. 4a,b are schematic illustrations to simulate a second hydrostatic drive;

FIGS. 5a,b are schematic illustrations to simulate a third hydrostatic drive; and

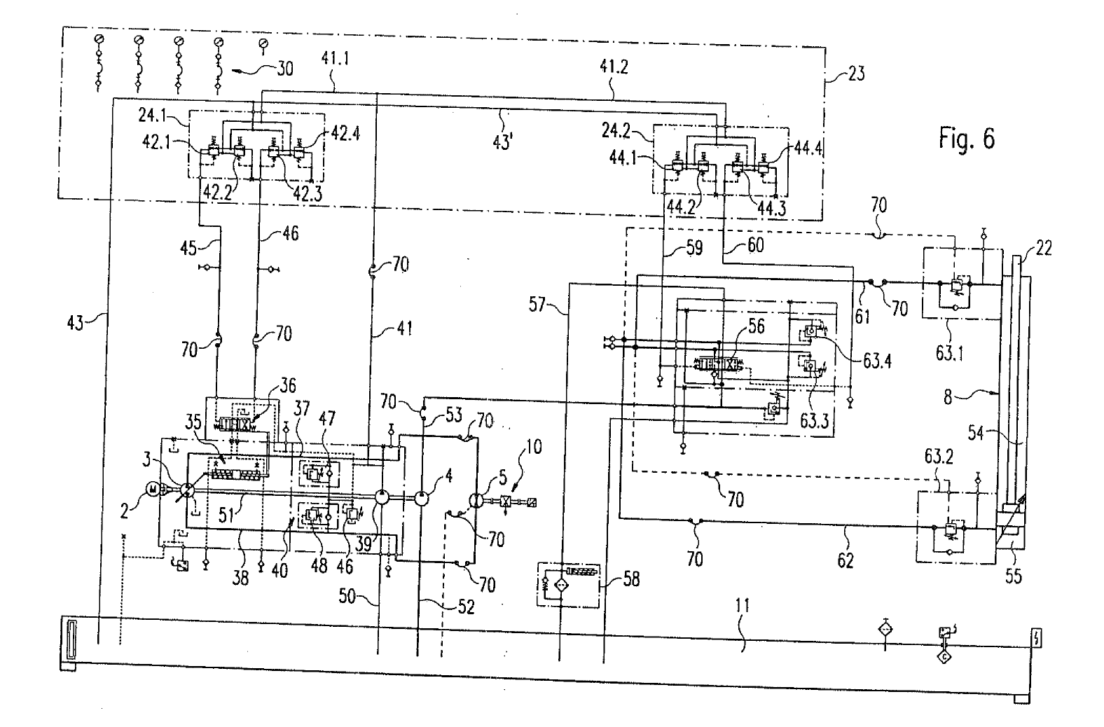

FIG. 6 is a hydrostatic circuit diagram to illustrate the co-operation of the hydraulic components.

With reference to FIGS. 1 and 2, the structure of the hydrostatic training device 1 is first described below. The hydrostatic training device 1 which is also referred to as a “Multi Mobile Trainer” comprises an electric motor 2 which is provided to drive the system. The electric motor 2 acts as a drive motor for a first hydraulic pump 3 and a second hydraulic pump 4. The first hydraulic pump 3 is provided to convey pressure medium in a closed circuit. However, the second hydraulic pump 4 is arranged in an open circuit.

The closed circuit comprises a hydraulic motor 5 in addition to the first hydraulic pump 3 and hydraulic lines which are not illustrated in FIG. 1. In the embodiment illustrated, the hydraulic motor 5 is constructed as an inclined axis motor. In particular, the hydraulic motor 5 can be constructed as a fixed displacement motor. Such a combination of a first hydraulic pump 3 which can be adjusted in terms of the supply volume thereof with a fixed displacement hydraulic motor 5 can often be found in travel drives.

The training device 1 further has an extension arm 7 which acts as a travel rail in the example illustrated. In order to produce a load for the hydrostatic drive, a weight 6 is arranged on the extension arm 7 and, as shown in the illustration of FIGS. 1 and 2, comprises a plurality of individual elements. Owing to this plurality of individual elements, which can be fixed to each other, for example, by means of a positive-locking connection, it is possible to simulate a different load for the hydrostatic drive.

The extension arm 7 is adjusted by means of a lifting cylinder 8 with respect to the inclination thereof relative to a frame member 12 of the training device 1.

Consequently, a linear drive 9 which is securely connected to the extension arm 7 is also adjusted with respect to the inclination thereof relative to the frame member 12 thereof. The linear drive 9 allows a slide which cannot be seen in FIGS. 1 and 2 to be displaced on the extension arm 7 in the direction of the longitudinal extent of the extension arm 7. The weight 6 is arranged on the slide so that the vehicle weight of a vehicle to be driven is simulated by means of the weight 6. In the embodiment illustrated, the linear drive 9 is constructed as a ball screw drive 10. The hydraulic motor 5 is connected to the threaded rod of the ball screw drive 10. If the hydraulic motor 5 is acted on with a pressure medium, it causes the threaded rod of the ball screw drive 10 to rotate. Consequently, a carrier nut of the hall screw drive 10 is displaced and a translation movement of the slide relative to the extension arm 7 is produced. Depending on the adjusted inclination of the extension arm 7 and the movement direction of the slide, a different travel resistance is consequently simulated for the hydrostatic drive. The simulation is not limited to travel drives.

Further examples are explained below with reference to FIGS. 3 to 5.

In order to be able to act on the lifting cylinder 8 with hydraulic medium, a tank 11 is provided and is connected to the second hydraulic pump 4 by means of an intake line.

The hydraulic components described above are all fixed in the frame member 12. The frame member 12 substantially comprises a lower frame 13 and an upper frame 14 which are connected to each other by means of vertical profile rods 15.1-15.4. The lower frame 13 has four profile rods 13.1-13.4 which are connected to each other in a right-angled arrangement. In a corresponding manner, the upper frame 14 is formed from four profile rods 14.1-14.4. The lower frame 13 has a greater longitudinal extent than the upper frame 14. Owing to the overhang which is formed at least at one side as a result of the differing lengths, at least one adjustment face 27 is formed. The adjustment face 27 is suitable, for example, for enabling additional training material to be transported in a simple manner together with the training device 1. In addition to the lower frame 13, the upper frame 14 and the vertical profile rods 15.1-15.4, additional profile rods are formed as reinforcements 16 on the frame member 12. The reinforcements 16 can be varied in accordance with the overall structure of the training device 1 and can be disassembled for component exchange.

In the lower region of the frame member 12 there is arranged a collection receptacle 17 which preferably covers the entire surface region below the hydraulic components. In the event of a leakage of the hydraulic components, any pressure medium which is discharged is thus collected in the collection receptacle 17.

The entire frame member 12 is arranged on rollers 18.1-18.4 so that the training device 1 can be transported in a simple manner. At least two rollers, for example, the rollers 18.1 and 18.4 can preferably be rotated about a vertical axis so that the training device can be manoeuvred in a simple manner.

The lifting cylinder 8 is connected to a cross-member 19 which is arranged in the lower frame 13 by means of a first articulated connection 20 so that this end of the lifting cylinder 8 is secured to the frame. The opposing end of the lifting cylinder 8 is connected to the extension arm 7 by means of a second articulated connection 21. The lifting cylinder may be active at one side or have a dual action. In accordance with a movement of a piston rod 22 of the lifting cylinder 8, by means of which the piston rod 22 is moved out of the lifting cylinder 8, the spacing between the two articulated connections is adjusted and thus the inclination of the extension arm 7 is adjusted. To this end, the extension arm 7 is fixed with one end to a rotary bearing 29. The rotary bearing 29 is preferably fixed to a narrow side of the upper frame 14 and has an axis of rotation which is orientated in a horizontal direction. The axis of rotation is perpendicular relative to a longitudinal axis of the extension arm 7. In a different manner to that illustrated, the extension arm 7 may also particularly preferably be arranged in such a manner that it is arranged inside the frame member 12. This facilitates a separation of the inner danger region from an operator, for example, by means of perspex panels or a hood.

The hydraulic motor 5 is preferably arranged at the end of the extension arm 7 on which the rotatable support is formed by means of the rotary bearing 29. When the inclination of the extension arm 7 is adjusted, the hydraulic motor is thereby changed only slightly in terms of its position, so that even limited flexibility of the hydraulic lines which connect the first hydraulic pump 3 to the hydraulic motor 5 is sufficient.

In order to influence the closed hydraulic circuit and the open hydraulic circuit, an operator console 23 is provided. The operator console 23 covers an electronics box 25. A first manual member 24.1 and a second manual member 24.2 are arranged on the operator console 23. The manual members 24.1 and 24.2 preferably correspond to the manual members which are also used for the operation of an actual vehicle or device. When an operating axis, for example, the horizontal axis is not occupied, this is preferably blocked.

In order to influence the function of the closed circuit and/or the open circuit, the control commands determined by the manual members 24.1 and 24.2 are implemented, for example, via control and regulation valves. Such valves are arranged in a casing 26 which is arranged as a closed casing 26 at one side of the frame member 12. In the embodiment illustrated, the height of the casing 26 is selected in such a manner that a depositing face 28 is produced at the upper side thereof and is delimited laterally by profile rods of the upper frame 14 or reinforcement profile rods.

In order to provide information for a participating trainee or an operator, a number of instruments 30 are also arranged in the operator console 23 and preferably indicate, for example, the system pressure at various locations of both the open and the closed hydraulic circuit. The casing 26 also contains additional electrical devices, such as, for example, a temperature monitor. If this is not required, it is also possible to dispense with the casing 26. This affords a better view of the hydraulic components. The measurement connections are preferably provided in a connection field arranged in the lower region of the frame 14. The arrangement in the lower region ensures good accessibility. In this instance, different threads are preferably used for the connections, in particular a high-pressure and a low-pressure connection in order to prevent occurrences of confusion and consequently damage to the measurement instruments.

The pipe bridging pieces used to connect the hydraulic components have non-return valves. Consequently, a leakage can substantially be prevented in the event of loosening during operation.

FIGS. 3a, b illustrate positioning of the extension arm 7 in the event of a horizontal movement. In this instance, for example, a hydrostatic travel drive of a vehicle is simulated by the linear drive 9. The slide on the extension arm 7 can be moved in translation by means of the linear drive, whereby both forward and backward travel and different acceleration situations can be simulated. The speed of the slide can be varied in a stepless manner by means of the hydrostatic drive of the closed circuit. By changing the weight 6 on the slide, the load for the travel drive is adjusted. FIG. 3a is a perspective view of the rear side of the training device 1. In contrast, FIG. 3b shows the side of the training device 1 facing an operator.

FIG. 4a is in turn a rear view and FIG. 4b a front view of the training device 1 according to the invention. The extension arm 7 is inclined relative to the upper frame 14 and consequently relative to the horizontal through approximately 45°. Owing to such an inclined position of the extension arm 7, it is possible to simulate, for example, a travel drive during travel on an incline. Since a low-friction ball screw drive 10 is preferably provided to produce the translation movement of the slide and consequently the weight 6, it is also possible to simulate the overrun of a vehicle during downhill travel using the training device 1 according to the invention.

If the extension arm 7 is finally moved into a vertical position, as illustrated in FIGS. 5a, 5b, the lifting and lowering of loads can be simulated by the closed hydrostatic circuit. In this manner, it is possible to simulate, for example, fork-lift and hoisting drives.

The use of the training device 1 is not limited to the examples described or the simulation thereof. It is, for example, also feasible for the closed circuit to be used purely to position the weight 6 on the extension arm 7 and subsequently, by raising and lowering and consequently changing the inclination of the extension arm 7, for the movement of an extension arm or a shaft of a digger to be simulated by means of the open circuit.

It should be noted in particular that actual components are used to construct the training device 1. That is to say, in particular, that demonstrations using the training device 1 are carried out using components which are identical to those used in a vehicle which has actually been produced. This ensures unlimited transferability of the simulation results to the actual hydrostatic drive.

FIG. 6 is a circuit diagram for the connection of the hydraulic components of the training device 1 according to the invention. Those components which have already been explained with reference to the structural configuration of the training device 1 are also referred to with the corresponding reference numerals in the hydraulic circuit diagram.

In order to form the closed hydraulic circuit, the first hydraulic pump 3 which is configured so as to be adjustable and to supply in two directions is connected to the hydraulic motor 5 by means of a first operating line 37 and a second operating line 38. The supply volume of the first hydraulic pump 3 can be adjusted by means of an adjustment device 35. The adjustment device 35 comprises a hydraulic cylinder in which an adjustment piston is arranged so as to be able to be longitudinally displaced. The adjustment piston can be acted on in each case with an adjustable adjustment pressure at mutually opposed adjustment piston faces. In order to adjust the adjustment pressure in a first adjustment pressure chamber and a second adjustment pressure chamber, an adjustment pressure regulation valve 36 is provided. The adjustment pressure regulation valve 36 either connects the adjustment pressure chambers which are arranged at both sides of the adjustment piston to a supply system 40 or depressurises the adjustment pressure chamber into a tank space. Owing to the pressure difference which is brought about, the adjustment piston is acted on in the hydraulic cylinder of the adjustment device 35 with a resultant axial force. The adjustment piston is connected to an adjustment mechanism of the first hydraulic pump 3.

The supply system 40 comprises a supply pump 39 which draws pressure medium from the tank 11 via an intake line 50 and conveys it into the supply system 40. The supply pump 39, together with the first hydraulic pump 3 and the second hydraulic pump 4, is driven by the electric motor 2. The supply pump 39, the first hydraulic pump 3 and the second hydraulic pump 4 are preferably connected to each other by means of a common drive shaft 51. The pressure medium conveyed by the supply pump 39 is in particular also supplied to a supply pressure line 41 which branches into a first supply pressure line branch 41.1 and a second supply pressure line branch 41.2. The first supply pressure line branch 41.1 is directed to the first manual member 24.1. The first manual member 24.1 comprises, for example, four control valves 42.1-42.4. Owing to the four control valves 42.1-42.4, a first control pressure line 45 and a second control pressure line 46 can be connected either to the supply pressure line 41 or a depressurisation line 43.

The first control pressure line 45 is connected to a first measurement face of the adjustment pressure regulation valve and the adjustment pressure regulation valve 36 is acted on in a first direction with the control pressure which is adjusted at that location. In the opposite direction, the adjustment pressure regulation valve 36 is acted on via the second control pressure line 46. Owing to the control valves 42.1-42.4, only one of the two control lines 45, 46 is acted on in each case with pressure from the supply pressure line 41, whilst at the same time the other is depressurised in the direction towards the tank 11 via the depressurisation line 43. Consequently, from the supply system 40, one of the two adjustment pressure chambers is acted on with an adjustment pressure via the adjustment pressure regulation valve 36 in accordance with the position of the adjustment pressure regulation valve 36, whilst the other adjustment pressure chamber is depressurised into the tank space. Consequently, a supply volume of the first hydraulic pump 3 is adjusted which corresponds in terms of the magnitude and direction to a deflection of the manual lever 24.1.

The supply system is also provided to produce a minimal pressure in the closed circuit. In order to secure the maximum pressure which is in the supply system 40 and which is produced by the supply pump 39, a pressure limitation valve 46 is provided. The supply system 40 further comprises a first supply valve unit 47 and a second supply valve unit 48, by means of which the first operating line 37 and the second operating line 38 can be filled with pressure medium. To this end, each supply valve unit 47, 48 has a non-return valve which opens in the direction towards the respective operating line 37, 38. In order to prevent a critical pressure increase in the operating line 37, 38, a pressure limitation valve is provided parallel with the non-return valve in each supply valve unit 47, 48 and depressurises the corresponding operating line 37, 38 into the supply system 40 when a pressure value which can be predetermined is exceeded.

The open circuit comprises, in addition to the second hydraulic pump 4 which is constructed as a fixed displacement pump in the embodiment illustrated, a second intake line 52 by means of which pressure medium is drawn from the tank 11 via the second hydraulic pump 4. The pressure medium conveyed by the second hydraulic pump 4 is conveyed into a supply line 53. A piston rod pressure space 54 and a piston pressure space 55 are formed in the lifting cylinder 8. Owing to a lifting cylinder regulation valve 56, the pressure in the supply line 53 can be supplied either to the piston rod pressure space 54 or the piston pressure space 55. Conversely, the other pressure space in each case is at the same time depressurised into the tank 11 by means of a second depressurisation line 57. In the second depressurisation line 57, a filter device 58 is provided. In a similar manner to that already explained in detail for the first manual member 24.1, a first and a second pressure can also be adjusted by the second manual member 24.2 and act on the lifting cylinder regulation valve 56. To this end, the lifting cylinder regulation valve 56, at a first control face and a second control face, can be acted on with the control pressures which are determined by the second manual member 24.2. To this end, the first control face of the lifting cylinder regulation valve 56 is connected to a control valve 44.1 of the second manual lever 24.2 by means of a third control line 59. Accordingly, a second control face of the lifting cylinder regulation valve 56 is connected to a third control valve 44.3 of the second manual member 24.2 by means of a fourth control pressure line 60.

In accordance with the resultant control force on the valve piston of the lifting cylinder regulation valve 56, the lifting cylinder regulation valve 56 which is constructed as a 6/3-way valve and which can be adjusted in a stepless manner between the end positions thereof, increasingly connects a first lifting cylinder adjustment pressure line or a second lifting cylinder adjustment pressure line 61, 62 to the supply line 53. At the same time, the other adjustment pressure line 62, 61 in each case is increasingly connected to the tank space.

In order to secure both the control of the lifting cylinder 8 and the lifting cylinder itself, four safety valves 63.1-63.4 are provided. The individual hydraulic components can be connected to each other by means of hydraulic connectors in the individual lines or on the components so that individual hydraulic components can be readily exchanged. The connection locations are each designated 70.

The invention is not limited to the embodiments illustrated. In particular, it is possible to replace individual hydraulic components with other hydraulic components.

1. Hydrostatic training device comprising a frame member, to which a first hydrostatic pump and a hydrostatic consumer which is connected thereto in a closed circuit is fixed, and an operator console for controlling the hydrostatic circuit.

2. Hydrostatic training device according to claim 1,
wherein
the hydrostatic consumer is a hydraulic motor.

3. Hydrostatic training device according to claim 1,
wherein
the training device, in order to adjust a load at least for the closed circuit, comprises an extension arm which can be adjusted in terms of the inclination thereof relative to the frame member.

4. Hydrostatic training device according to claim 3,
wherein
the extension arm is fixed to the frame member by means of a rotary bearing and the axis of rotation of the rotary bearing extends perpendicularly relative to a longitudinal axis of the extension arm and in a horizontal direction.

5. Hydrostatic training device according to claim 3,
wherein
the inclination of the extension arm can be adjusted by means of a lifting cylinder.

6. Hydrostatic training device according to claim 3,
wherein
the inclination of the extension arm can be adjusted in at least one angular range which allows a horizontal and a vertical positioning of the extension arm.

7. Hydrostatic training device according to claim 3,
wherein
a slide is connected to the extension arm and can be longitudinally displaced in the direction of the longitudinal axis of the extension arm.

8. Hydrostatic training device according to claim 7,
wherein,
in order to produce a translation movement relative to the extension arm, the slide co-operates with a linear drive.

9. Hydrostatic training device according to claim 8,
wherein
the linear drive is a ball screw drive which is driven by means of a hydraulic motor and can be driven at the side of the extension arm orientated towards the rotary bearing.

10. Hydrostatic training device according to claim 7,
wherein
a weight can be secured to the slide.

11. Hydrostatic training device according to claim 1,
wherein,
in addition to the closed circuit, an open circuit is provided and comprises a second hydrostatic pump.

12. Hydrostatic training device according to claim 11,
wherein
the open hydraulic circuit can also be controlled by means of the operator console.

13. Hydrostatic training device according to claim 1,
wherein
the frame member is constructed in a parallelepipedal manner.

14. Hydrostatic training device according to claim 13,
wherein
the parallelepipedal frame member has a lower frame which is extended at least at one side.

15. Hydrostatic training device according to claim 1,
wherein
the frame member is formed from profile rods.

16. Hydrostatic training device according to claim 15,
wherein
the profile rods form an open frame member in which hydraulic components of the closed circuit and/or the open circuit are arranged so as to be accessible from the outer side.

17. Hydrostatic training device according to claim 1,
wherein
the hydraulic components of the closed circuit and/or the open circuit are arranged so as to be visible from the outer side.
